(19) United States
(12) Patent Application Publication
(10) Pub. No.: US 2018/0015609 A1
(43) Pub. Date: Jan. 18, 2018

(54) WRENCH

(71) Applicant: Jia-Guann Liau, Taichung (TW)

(72) Inventor: Jia-Guann Liau, Taichung (TW)

(21) Appl. No.: 15/208,625

(22) Filed: Jul. 13, 2016

(51) Int. Cl. B25G 1/10; B25B 13/04; B25B 13/08; B25B 13/46

(52) U.S. Cl. CPC B25G 1/102; B25B 13/461; B25B 13/04; B25B 13/08

(57) ABSTRACT

A wrench includes a body having a handle which a first face defined in each of top and bottom thereof. Each of the two first faces has two first recesses defined therein. Each of the first faces has a first block which protrudes beyond the first face corresponding thereto. The handle has a first function head formed on the first end thereof. The first function head is an open wrench head. The first function head has a first protrusion which is connected to the handle and protrudes beyond the first face. The first protrusion has a second curved face formed on the distal end thereof. The handle has a second function head formed on the second end thereof. The second function head is a box-end wrench head.

### BACKGROUND OF THE INVENTION

### 1. Fields of the Invention

The present invention relates to a wrench, and more particularly, to a handle of a wrench and the handle includes a first recess for reducing weight, and a first protrusion for reinforcing structural strength.

### 2. Descriptions of Related Art

The conventional wrench known to applicant is disclosed in U.S. patent application Ser. No. 14/753,037, and comprises a body which has a handle, a first function head is connected to one end of the handle and is an open-end wrench head. The first function head has a first layer, a second layer and a third layer. The first layer has a U-shaped cross section and is connected to the handle. The second layer protrudes from the top and bottom of the first layer. The second layer is located around the open end of the first function head and away from the handle. The cross section of the second layer is smaller than that of the first layer. The third layer is connected to the first and second layers. The third layer is located on the side of the top and the bottom of the first layer. The first layer has a fourth layer which extends to the handle. The second layer has a fifth layer which extends to the handle. The third layer has a sixth layer which extends to the handle. The first layer of the first function head has a first cross section. The second layer of the first function head has a second cross section. The second cross section is smaller than the first cross section. The third layer is located between the first and second cross sections, and is a transitional portion when the first cross section gradually becomes into the second cross section. The fourth layer of the first function head has a third cross section. The fifth layer of the first function head has a fourth cross section which is smaller than the third cross section. The sixth layer is located between the third and fourth cross sections, and is a transitional portion when the third cross section gradually becomes into the fourth cross section.

Although there is a recess defined in the handle to reduce the weight of the handle, the recess actually reduces the torque that the handle can bear. In other words, the handle may be broken at the position where the recess is located when a large torque is applied.

The present invention intends to provide a wrench which improves the problem of weak strength of the handle because of the recess defined in the handle. The handle has a first face defined in each of top and bottom thereof. Each of the two first faces has two first recesses defined therein. Each of the first faces has a first block which protrudes beyond the first face corresponding thereto. The first recesses reduce the weight of the handle, and the first blocks reinforce the strength of the handle. The handle gets a balance between the weight and torque.

### SUMMARY OF THE INVENTION

The present invention relates to a wrench which comprises a body having a handle which a first face defined in each of top and bottom thereof. Each of the two first faces has two first recesses defined therein. Each of the first faces has a first block which protrudes beyond the first face corresponding thereto. The handle has a first function head formed on the first end thereof. The first function head is an open wrench head. The first function head has a first protrusion which is connected to the handle and protrudes beyond the first face. The first protrusion has a second curved face formed on the distal end thereof. The handle has a second function head formed on the second end thereof. The second function head is a box-end wrench head.

Compared with the conventional wrench, the handle has a first face defined in each of top and bottom thereof. Each of the two first faces has two first recesses defined therein. Each of the first faces has a first block which protrudes beyond the first face corresponding thereto. The first recesses reduce the weight of the handle, and the first blocks reinforce the strength of the handle. The handle gets a balance between the weight and torque.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is a top view of the wrench of the present invention;

FIG. 3 is a side view of the wrench of the present invention;

FIG. 4 is a perspective view to show the second embodiment of the wrench of the present invention;

FIG. 5 is a side view of the second embodiment of the wrench of the present invention;

FIG. 6 is a perspective view to show the third embodiment of the wrench of the present invention;

FIG. 7 is a perspective view of the fourth embodiment of the wrench of the present invention;

FIG. 8 is a perspective view of the fifth embodiment of the wrench of the present invention;

FIG. 9 is a side view of the fifth embodiment of the wrench of the present invention;

FIG. 10 is a perspective view of the sixth embodiment of the wrench of the present invention;

FIG. 11 is a side view of the sixth embodiment of the wrench of the present invention, and

FIG. 12 is a perspective view of the seventh embodiment of the wrench of the present invention.

### DETAILED DESCRIPTION OF THE PREFERRED EMBODIMENT

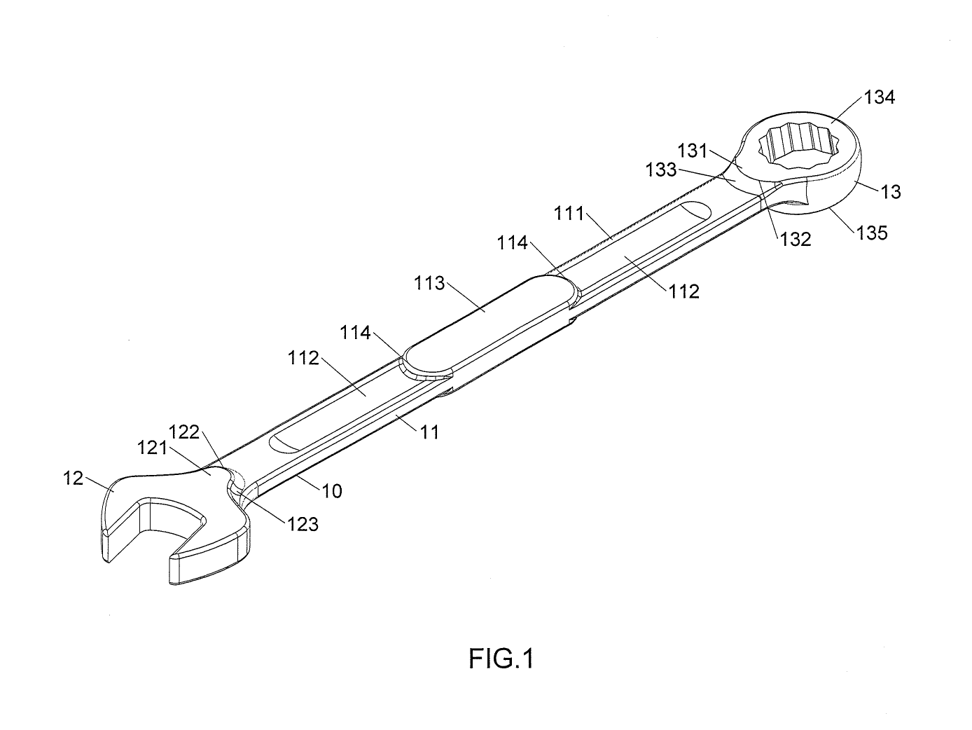

Referring to FIG. 1, the wrench of the present invention comprises a body 10 having a handle 11 which has a first face 111 defined in each of the top and the bottom thereof. Each of the faces 111 is a planar surface. Each of the two first faces 111 has two first recesses 112 defined therein. Each of the first faces 111 has a first block 113 which protrudes beyond the first face 111 corresponding thereto. The first blocks 113 each are an oval block and have a first curved face 114 formed at each of two ends thereof. The first curved faces 114 each are a circular and curved face. The first block 113 on each of the first faces 111 connected between the two first recesses 112. The handle 10 has a certain length.

The handle 11 has a first function head 12 formed on the first end thereof, and the first function head 12 is an open wrench head. The first function head 12 has a first protrusion 121 which is connected to the handle 11 and protrudes beyond the first face 111. The first protrusion 121 has a second curved face 122 formed on the distal end thereof. The second curved face 122 is a circular and curved face. The first protrusion 121 has a first ramp 123 which is connected between the handle 11 and the first protrusion 121. The first ramp 123 is a rounded ramp or an inclined ramp.

The handle 11 has a second function head 13 formed on the second end thereof. The second function head 13 is a box wrench head. The second function head 13 has a second protrusion 131 which is connected to the handle 11 and protrudes beyond the first face 111. The second protrusion 131 has a third curved face 132 formed on the distal end thereof. The third curved face 132 is a circular and curved face. The second protrusion 131 has a second ramp 133 which is connected between the handle 11 and the second protrusion 131. The second ramp 133 is a rounded ramp or an inclined ramp. The second function head 13 has a second face 134 formed on the top thereof, and a third face 135 formed on the bottom thereof. The second face 134 is parallel to the first face 111. The second face 134 is not parallel to the third face 135 which is not parallel to the first face 111.

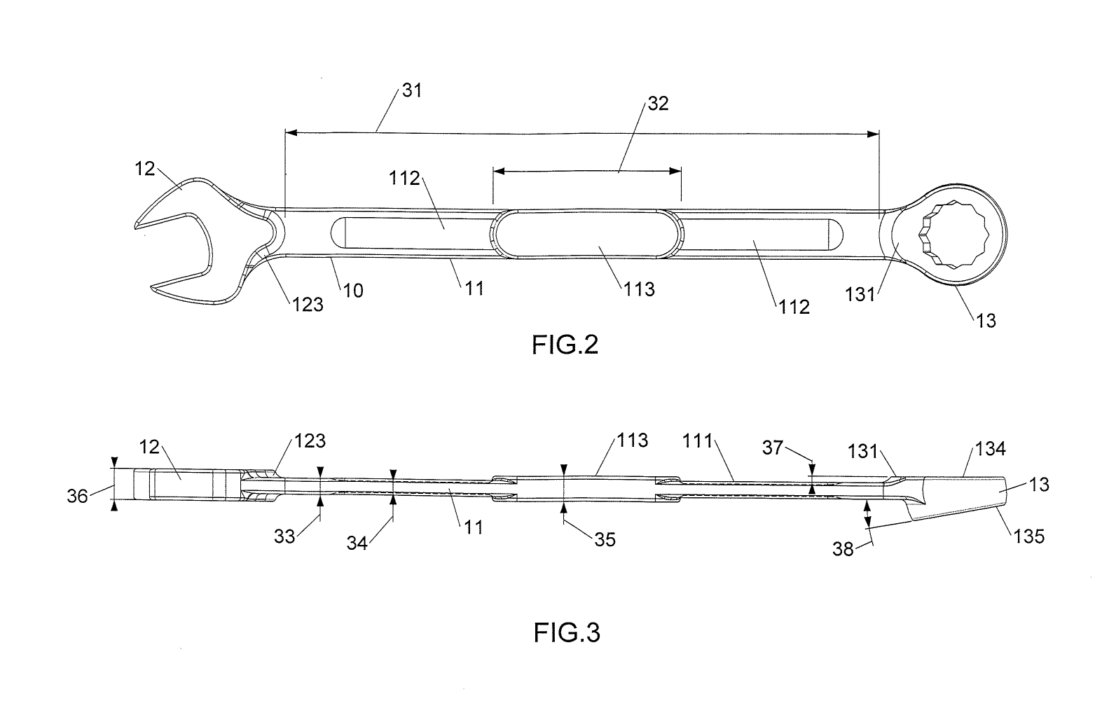

As shown in FIGS. 2 and 3, the shortest length of the handle 11 is the first length 31. The maximum length of the first block 113 is the second length 32. The ratio between the first length 31 and the second length 32 is located in a range of 4:1 to 2:1. The ratio between the first length 31 and the second length 32 is located in a range of 3.5:1 to 2.5:1. The ratio between the first length 31 and the second length 32 is close to 3:1. The thickness of the handle 11 is the first thickness 33, and the thickness between two respective surfaces of the two first recesses 112 corresponding thereto is the second thickness 34. The thickness of the first block 113 is the third thickness 35. The thickness of the first function head 12 is the fourth thickness 36. The ratio between the first thickness 33 and the second thickness 34 is located in a range of 1.7:1 to 1.3:1. The ratio between the third thickness 35 and the first thickness 33 being located in a range of 1.7:1 to 1.3:1. The fourth thickness 36 is thicker than the third thickness 35. The distance between the first face 111 and the second face 134 is the first distance 37. The ratio between the first thickness 33 and the first length 37 is located in a range of 3:1 to 2:1. A first angle 38 is defined between the first face 111 and the third face 135, and the first angle 38 is located in a range of 10 to 15 degrees. Preferably, the first angle 38 is 15 degrees.

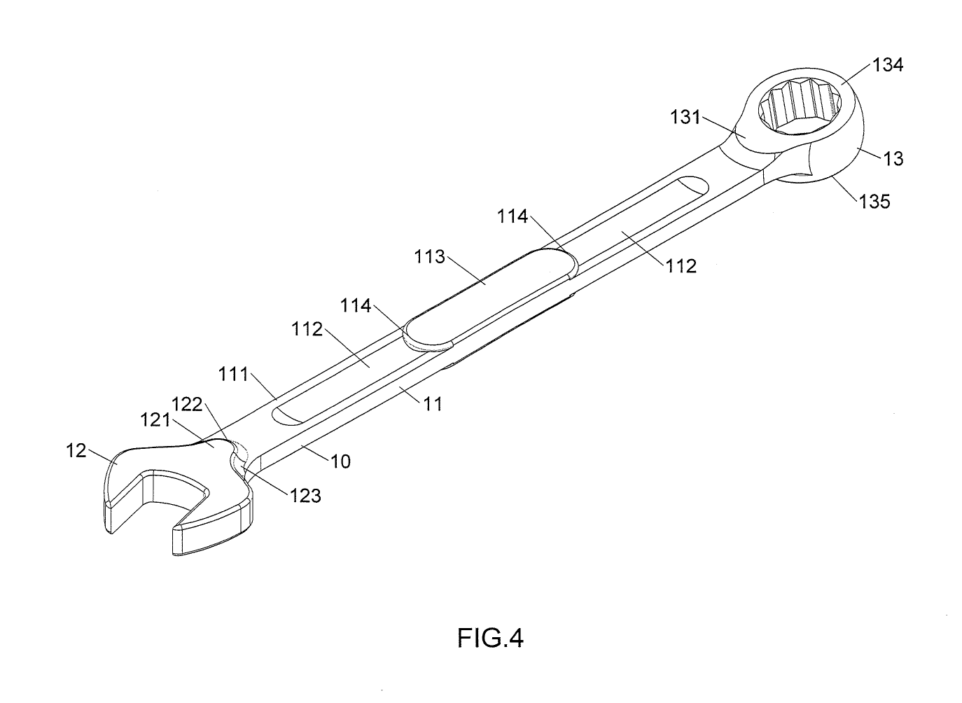

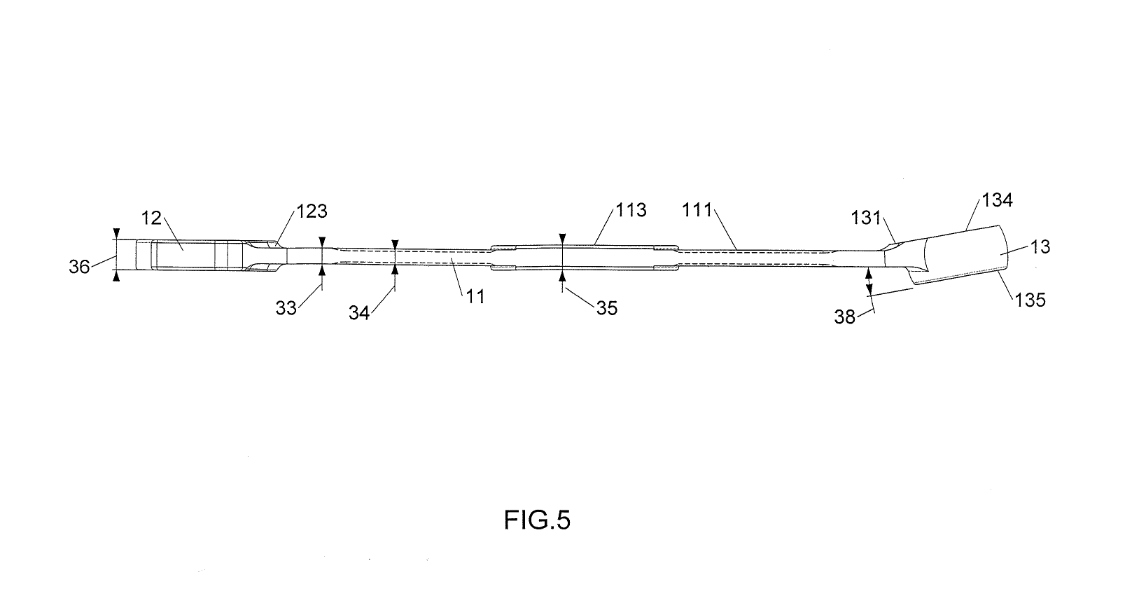

As shown in FIGS. 4 and 5, the second embodiment of the present invention is disclosed wherein the second face 134 is parallel to the third face 135, and the second and third faces 134, 135 are not parallel to the first face 111.

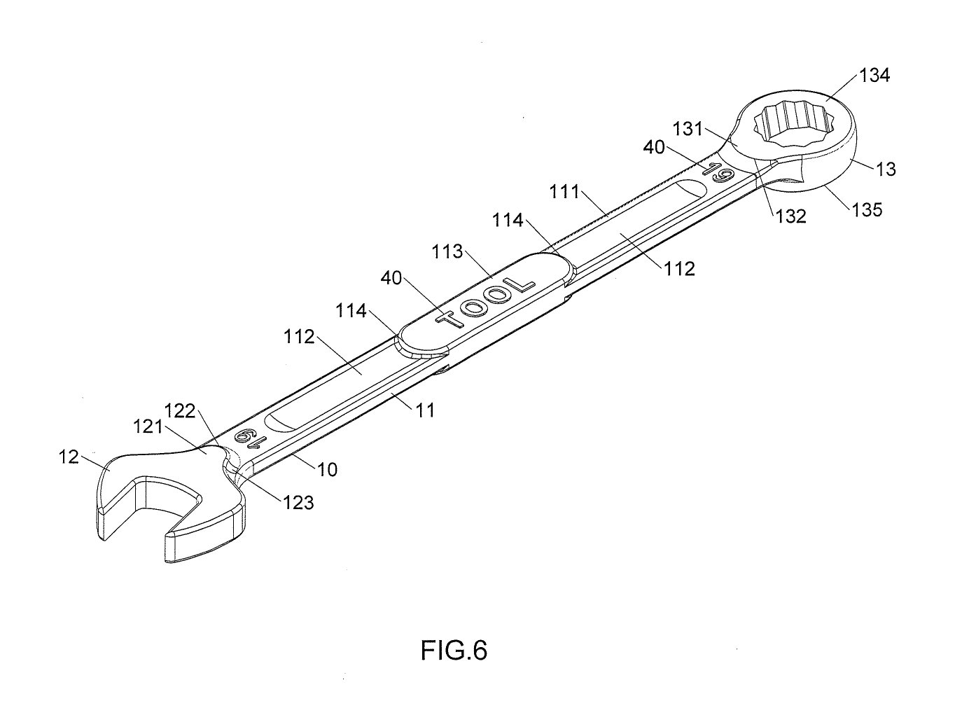

As shown in FIG. 6, which shows the third embodiment of the present invention, wherein each of the first faces 111 and each of the first blocks 113 has marks 40 formed thereon.

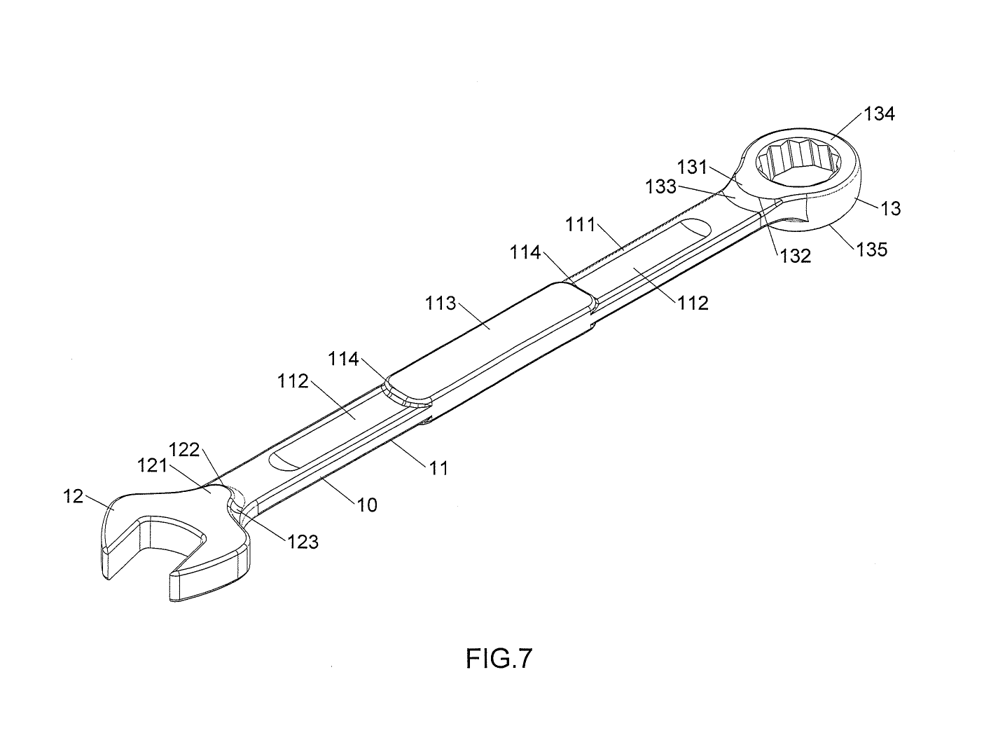

As shown in FIG. 7, which shows the fourth embodiment of the present invention, wherein the shape of the first block 113 is different from that disclosed in FIG. 1.

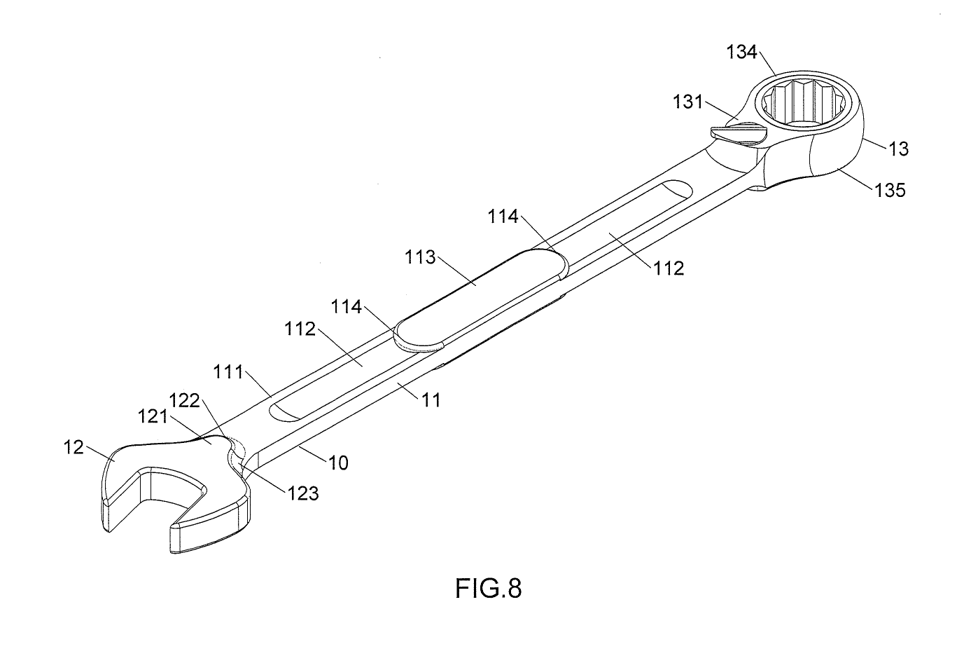

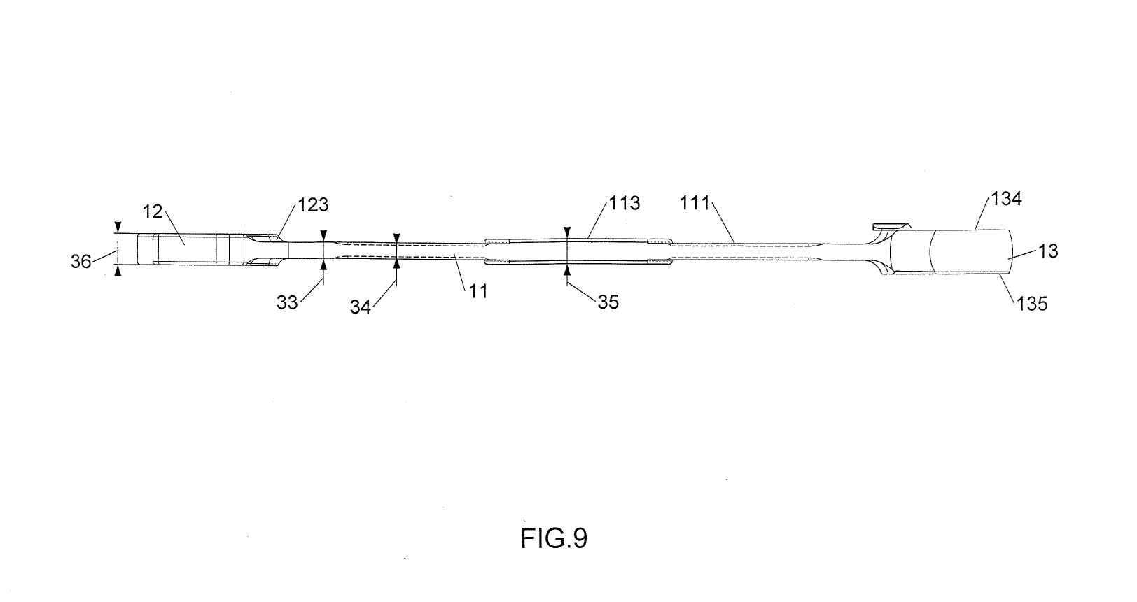

As shown in FIGS. 8 and 9, which show the fifth embodiment of the present invention, wherein the second function head 13 is a box-end wrench head which is a dual-direction ratchet head or a one-direction ratchet head.

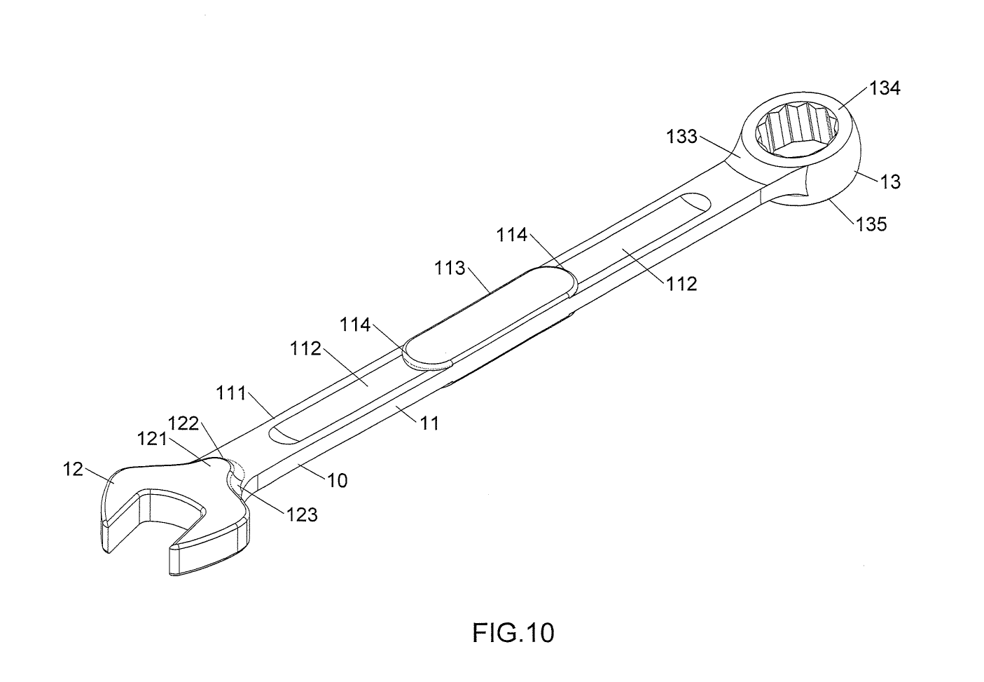

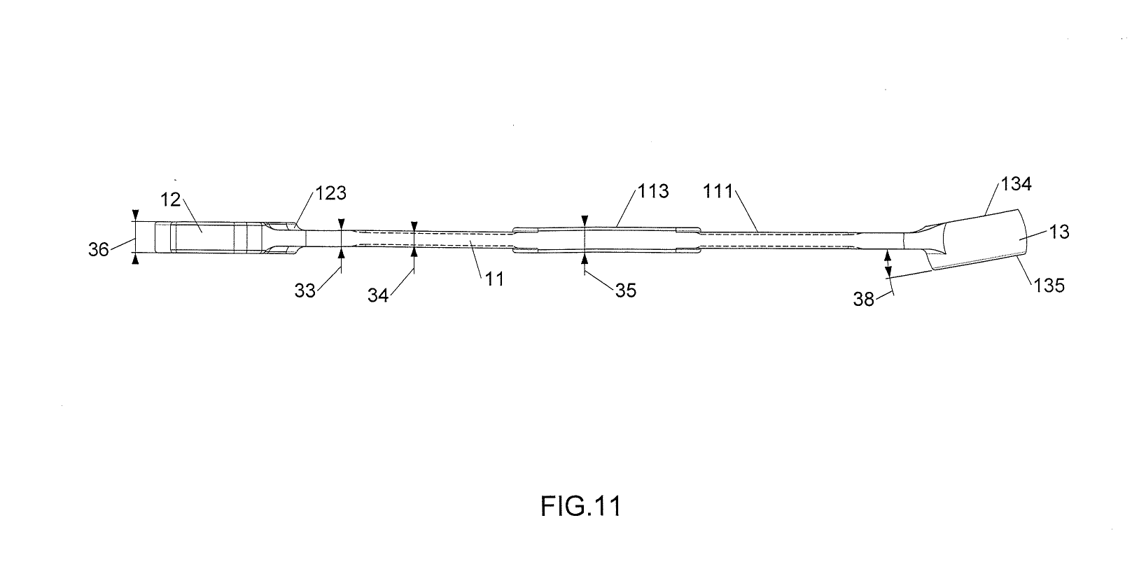

As shown in FIGS. 10 and 11, which show the sixth embodiment of the present invention, wherein the second function head 13 does not have the second protrusion 131 and the second curved face 132. The second face 134 and the third face 135 of the second function head 13 are parallel to each other.

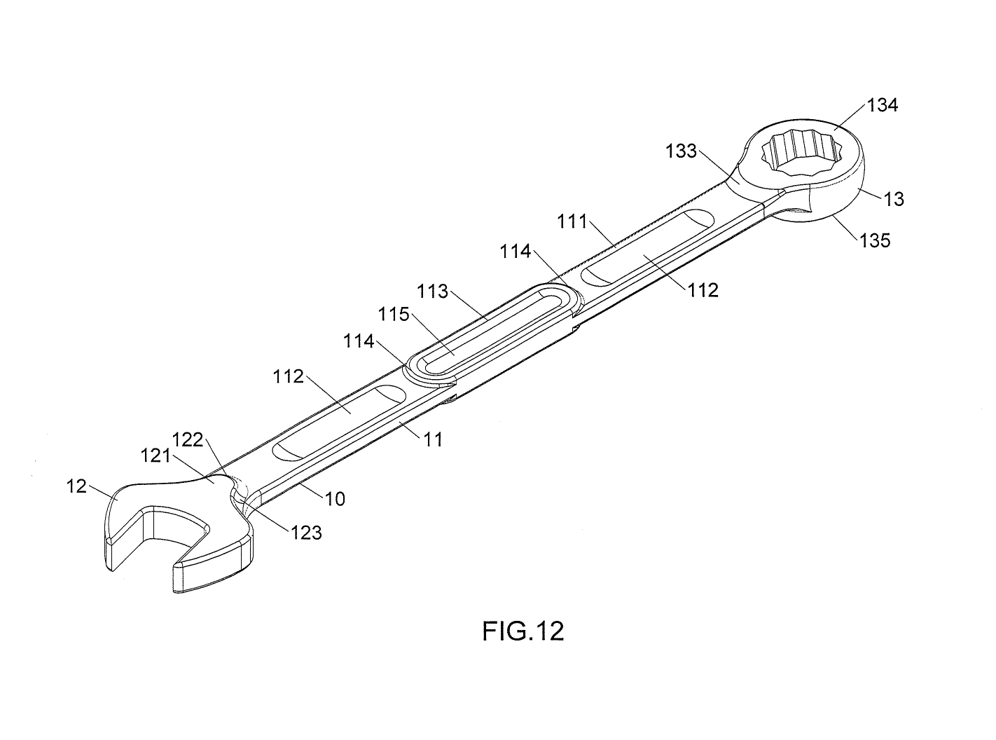

As shown in FIG. 12, which shows the seventh embodiment of the present invention, wherein each of the first blocks 113 of the body 10 has a recessed area 115 which reduces the weight of the first block 113. In other words, the recessed areas 115 reduce the weight of the wrench. The recessed areas 115 each are an oval shape recess.

Another embodiment of the present invention may be arranged that the handle 10 has the first function head 12 formed on each of the first and second ends thereof, or the handle 10 has the second function head 13 formed on each of the first and second ends thereof.

The advantages of the present invention are that each of the two first faces 111 has the two first recesses 112 defined therein. Each of the first faces 111 has the first block 113 which protrudes beyond the first face 111 corresponding thereto. The first block 113 on each of the first faces 111 connected between the two first recesses 112. The first recesses 121 reduce the weight of the handle 11, and the first blocks 113 handle 10 reinforce the structural strength of the wrench so as to output a larger torque. The handle of the present invention maintains a balance between the torque and the weight.

When holding the handle 11 to rotate the wrench, the thumb contacts against the first block 131 of the handle 11. The thickness of the first block 113 is the third thickness 35 which is thicker than the first thickness 33. The user's thumb can easily contacts against the first block 131 with the third thickness 35.

When holding the handle 11 to rotate the wrench, the thumb contacts against the conjunction area between the first recess 112 and the first block 131 of the handle 11. In other words, the first curved face 114 allows the user to easily hold the handle.

The user can contact his/her thumb against either at the first block 131 of the handle 11, or the conjunction area between the first recess 112 and the first block 131 of the handle 11. The user can conveniently operate the wrench.

The first block 131 is located between the two first recesses 113. The handle 11 has the first thickness 33, the second thickness 34, and the third thickness 35. The third thickness 35 is located between the first thickness 33 and the second thickness 34. The handle 11 has three different thicknesses which make the outer appearance of the handle 11 be more attractive.

The first function head 12 has the first protrusion 121 which increase the torque that the first function head 12 bears. The first protrusion 121 also increases the strength at the position where the first function head 12 connected to the handle 11.

The second function head 13 has the second protrusion 131 which increase the torque that the second function head 13 bears. The second protrusion 131 also increases the strength at the position where the second function head 13 connected to the handle 11.

As shown in FIG. 6, each of the first faces 111 and each of the first blocks 113 has marks 40 formed thereon. The marks 40 can be used to disclose the brand name or the trademark, or the specifications of the wrench.

While we have shown and described the embodiment in accordance with the present invention, it should be clear to those skilled in the art that further embodiments may be made without departing from the scope of the present invention.

What is claimed is:

1. A wrench comprising:
a body having a handle which has a first face defined in each of top and bottom thereof, each of the two first faces having two first recesses defined therein, each of the first faces having a first block which protrudes beyond the first face corresponding thereto, the first block on each of the first faces connected between the two first recesses;
the handle having a first function head formed on a first end thereof, the first function head being an open wrench head, the first function head having a first protrusion which is connected to the handle and protrudes beyond the first face, the first protrusion having a second curved face formed on a distal end thereof, the second curved face being a circular and curved face, the first protrusion having a first ramp which is connected between the handle and the first protrusion, the first ramp being a rounded ramp or an inclined ramp;
the handle having a second function head formed on a second end thereof, the second function head being a box wrench head, the second function head having a second protrusion which is connected to the handle and protrudes beyond the first face, the second protrusion having a third curved face formed on a distal end thereof, the third curved face being a circular and curved face, the second protrusion having a second ramp which is connected between the handle and the second protrusion, the second ramp being a rounded ramp or an inclined ramp, the second function head having a second face formed on a top thereof and a third face formed on a bottom thereof, the second face being parallel to the first face, the second face being not parallel to the third face which is not parallel to the first face;
a shortest length of the handle being a first length, a maximum length of the first block being a second length, a ratio between the first length and the second length being located in a range of 4:1 to 2:1, a thickness of the handle being a first thickness, a thickness between two respective surfaces of the two first recesses corresponding thereto being a second thickness, a thickness of the first block being a third thickness, a thickness of the first function head being a fourth thickness, a ratio between the first thickness and the second thickness being located in a range of 1.7:1 to 1.3:1, a ratio between the third thickness and the first thickness being located in a range of 1.7:1 to 1.3:1, the fourth thickness being thicker than the third thickness, a distance between the first face and the second face being a first distance, a ratio between the first thickness and the first length being located in a range of 3:1 to 2:1, a first angle defined between the first face and the third face, the first angle being located in a range of 10 to 15 degrees.

2. The wrench as claimed in claim 1, wherein each of the faces is a planar surface.

3. The wrench as claimed in claim 1, wherein the first blocks each are an oval block and have a first curved face formed at each of two ends thereof, the first curved faces each are a circular and curved face.

4. The wrench as claimed in claim 1, wherein the ratio between the first length and the second length is located in a range of 3.5:1 to 2.5:1.

5. The wrench as claimed in claim 1, wherein the ratio between the first length and the second length is close to 3:1.

6. The wrench as claimed in claim 1, wherein each of the first faces and each of the first blocks has marks formed thereon.

7. The wrench as claimed in claim 1, wherein the second function head is a box-end wrench head which is a dual-direction ratchet head or a one-direction ratchet head.

8. The wrench as claimed in claim 1, wherein each of the first blocks of the body has a recessed area which reduces a weight of the first block.
